(19) United States
(12) Patent Application Publication
(10) Pub. No.: US 2014/0045163 A1
(43) Pub. Date: Feb. 13, 2014

(54) INTERACTIVE RESPONSE SYSTEM AND QUESTION GENERATION METHOD FOR INTERACTIVE RESPONSE SYSTEM

(71) Applicant: Chun-Yu Chen, New Taipei City (TW)

(72) Inventor: Chun-Yu Chen, New Taipei City (TW)

(21) Appl. No.: 13/610,821

(22) Filed: Sep. 11, 2012

(30) Foreign Application Priority Data
Aug. 10, 2012 (TW) 101128973

(51) Int. Cl. G09B 3/00

(52) U.S. Cl. 434/350

(57) ABSTRACT

A question generation method for interactive response system includes steps of executing an interactive response program in a host device, wherein the host device includes a memory module and the interactive response program includes a question generation module; enabling a manager device and a plurality of user devices to communicate with the host device, wherein the manager device includes a hot operation module; operating the manager device to browse an object; operating the manager device to select a content within the object; operating the hot operation module to trigger the interactive response program to copy the content to the memory module; and controlling the question generation module to generate a question relative to the content for the user devices to answer.

### BACKGROUND OF THE INVENTION

1. Field of the Invention

The invention relates to an interactive response system and, more particularly, to a question generation method for an interactive response system.

2. Description of the Prior Art

As technology develops and advances, various electronic devices including flat computer, cell phone, personal digital assistant, and so on are getting more and more popular. So far an interactive response system (IRS) has been developed and adapted for the aforesaid electronic devices so as to enhance interaction between teacher and students and improve ambiance in a classroom. The IRS transmits and collects information through communication technology and processes information and displays response information of students through computer so as to improve teaching and learning effects. However, for the conventional IRS, a teacher can only use a question database built in the system to generate questions and can only edit the questions in the system. That is to say, the conventional IRS lacks flexibility and variation in use. If the teacher finds a content, which is suitable for generating questions, in Internet, he or she can only use a printscreen key on a keyboard to copy the content and then pastes the content on a question editing region of the IRS for edition. If it is needed to retrieve a plurality of different contents from Internet for generating questions, the teacher has to switch different windows frequently to copy and paste contents and edit questions with related contents. The aforesaid operation is very inconvenient for the teacher.

### SUMMARY OF THE INVENTION

The invention provides an interactive response system and a question generation method for the interactive response system so as to solve the aforesaid problems.

According to the claimed invention, an interactive response system comprises a host device, a plurality of user devices and a manager device. The host device is used for executing an interactive response program, wherein the host device comprises a memory module and the interactive response program comprises a question generation module. The plurality of user devices communicates with the host device. The manager device communicates with the host device and comprises a hot operation module. The manager device is used for browsing an object and selecting a content within the object. The hot operation module is operated to trigger the interactive response program to copy the content to the memory module. The manager device controls the question generation module to generate a question relative to the content for the user devices to answer.

According to the claimed invention, after generating the question, the hot operation module is operated to trigger the question generation module to take the content to be a choice corresponding to the question.

According to the claimed invention, the question generation module renders the choice in a multimedia form.

According to the claimed invention, the multimedia form comprises an animation, a voice, or a combination thereof.

According to the claimed invention, the memory module stores a plurality of questions and the hot operation module is operated to trigger the question generation module to select at least one question from the plurality of questions for the user devices to answer.

According to the claimed invention, the host device is linked with an Internet and the manager device browses the object in the Internet.

According to the claimed invention, the hot operation module comprises a key, a mouse, a microphone, a camera, or a combination thereof.

According to the claimed invention, a question generation method for interactive response system comprises steps of executing an interactive response program in a host device, wherein the host device comprises a memory module and the interactive response program comprises a question generation module; enabling a manager device and a plurality of user devices to communicate with the host device, wherein the manager device comprises a hot operation module; operating the manager device to browse an object; operating the manager device to select a content within the object; operating the hot operation module to trigger the interactive response program to copy the content to the memory module; and controlling the question generation module to generate a question relative to the content for the user devices to answer.

According to the claimed invention, the question generation method further comprises step of operating the hot operation module to trigger the question generation module to take the content to be a choice corresponding to the question after generating the question.

According to the claimed invention, the question generation method further comprises step of rendering the choice in a multimedia form.

According to the claimed invention, wherein the multimedia form comprises an animation, a voice, or a combination thereof.

According to the claimed invention, the memory module stores a plurality of questions and the question generation method further comprises step of operating the hot operation module to trigger the question generation module to select at least one question from the plurality of questions for the user devices to answer.

According to the claimed invention, the question generation method further comprises steps of linking the host device with an Internet; and operating the manager device to browse the object in the Internet.

According to the claimed invention, the hot operation module comprises a key, a mouse, a microphone, a camera, or a combination thereof.

As mentioned in the above, when a manager (e.g. teacher) operates the manager device to browse an object (e.g. Website, document, video or other files) and finds a content (e.g. graph, text, animation or other forms), which is suitable for generating questions, within the object, he or she can select the content within the object first and then operate the hot operation module to copy the content to the memory module of the host device. Afterward, the manager can operate the manager device to control the question generation module to generate a question relative to the content for users (e.g. students) to see and further operate the user devices to answer. The hot operation module of the invention may be a key, a mouse, a microphone, a camera, or a combination thereof. In other words, the manager only has to perform a trigger action (e.g. press the key, press the mouse, generate a voice in front of the microphone, perform a gesture in front of the camera, etc.) after selecting the desired content such that the interactive response program retrieves the desired content accordingly for question generation purpose. Therefore, the invention can simplify the operation of generating questions in the interactive response system effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an interactive response system according to an embodiment of the invention.

FIG. 2 is a functional block diagram illustrating the interactive response system shown in FIG. 1.

FIG. 3 is a schematic diagram illustrating the manager operating the computer of the manager device to browse an object.

FIG. 4 is a schematic diagram illustrating a question and the choice corresponding thereto shown on the digital signage.

FIG. 5 is a flowchart illustrating a question generation method for the interactive response system according to an embodiment of the invention.

### DETAILED DESCRIPTION

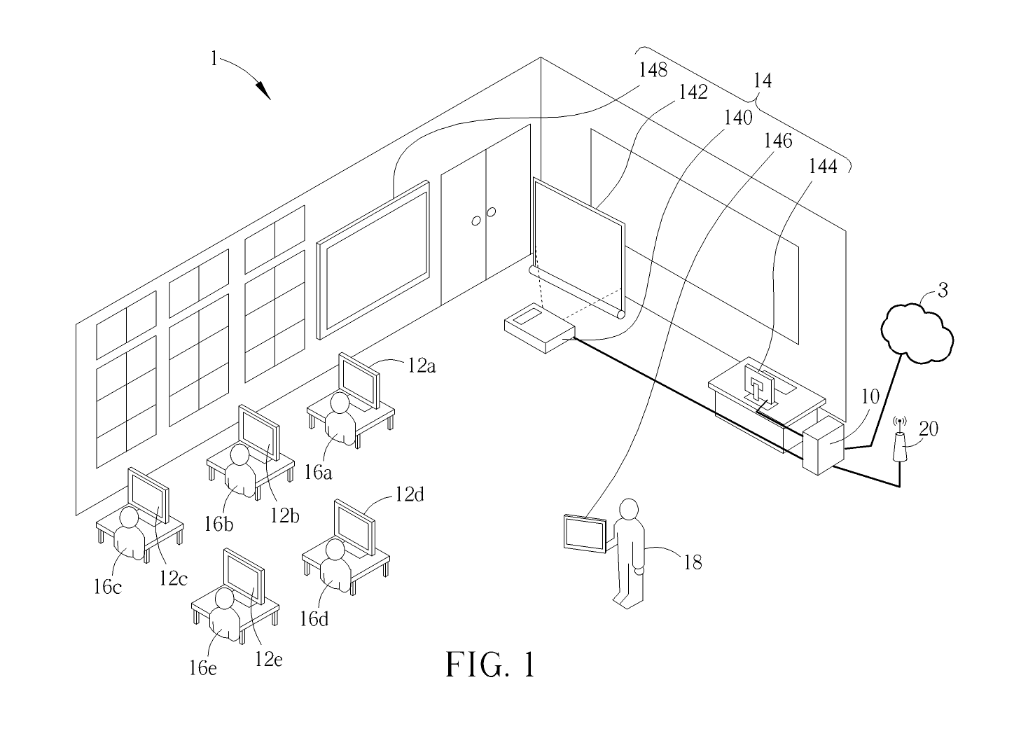

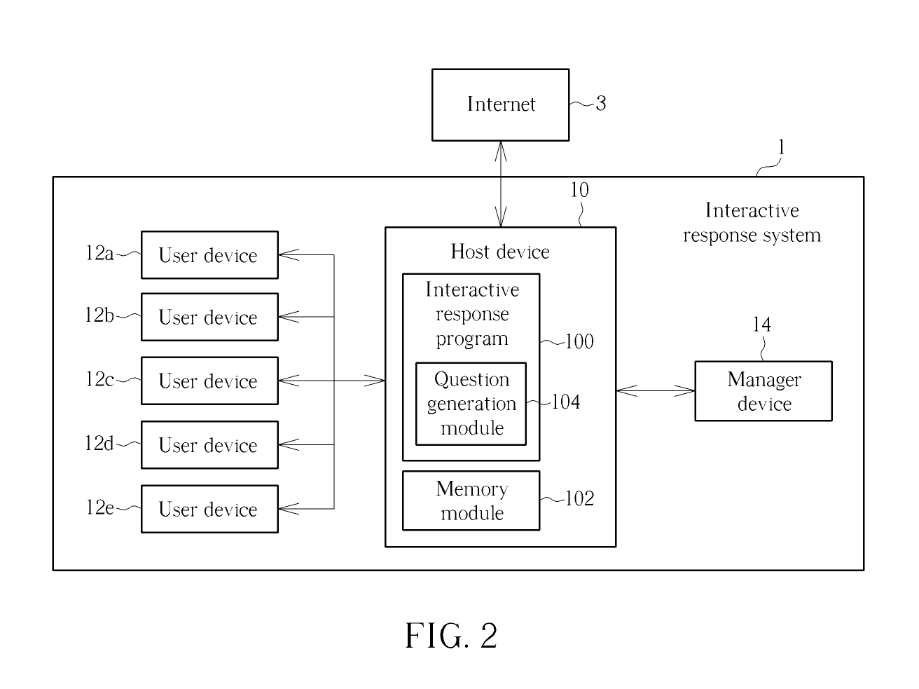

Referring to FIGS. 1 and 2, FIG. 1 is a schematic diagram illustrating an interactive response system 1 according to an embodiment of the invention, and FIG. 2 is a functional block diagram illustrating the interactive response system 1 shown in FIG. 1. As shown in FIG. 1, the interactive response system 1 comprises a host device 10, a plurality of user devices 12a-12e and a manager device 14. As shown in FIG. 2, the host device is used for executing an interactive response program 100. In this embodiment, the host device 10 comprises a memory module 102 and the interactive response program 100 comprises a question generation module 104. The memory module 102 may be a sharing system memory in the host device 10. The interactive response program 100 and the question generation module 104 can be implemented by programming. In practical applications, the host device 10 may be further equipped with an operating system (OS) and other necessary hardware or software components for specific purposes and those will not be depicted herein. It should be noted that the host device 10 may be a server or a common computer based on practical applications. Furthermore, the host device 10 can be linked with an Internet 3 so as to be linked with various servers through the Internet 3.

In this embodiment, the user devices 12a-12e are provided for users (e.g. students) 16a-16e respectively. Each of the user devices 12a-12e can communicate with the host device 10 in wireless via an access point (AP) 20. It should be noted that each of the user devices 12a-12e may be a flat computer, a cell phone, a personal digital assistant or other electronic devices capable of communicating with the host device 10 via the AP 20 based on practical applications.

In this embodiment, the manager device 14 is used for a manager (e.g. teacher) 18 to operate the question generation module 104 of the interactive response program 100 to generate questions for the users 16a-16e to answer. As shown in FIG. 1, the manager device 14 may comprise a projector 140, a projecting screen 142, a computer 144, a portable electronic device 146 (e.g. flat computer) and a digital signage 148. The projector 140 and the computer 144 are electrically connected to the host device 10 so as to communicate with the host device 10. The portable electronic device 146 and the digital signage 148 can communicate with the host device 10 in wireless via the AP 20. Accordingly, the manager 18 can use the computer 144 or the portable electronic device 146 to operate the interactive response program 100 and broadcast specific file or message by the projector 140 and the projecting screen 142. Furthermore, the manager 18 can transmit specific document or message to the aforesaid question generation module 104 of the interactive response program 100 to generate questions and display the questions on the projecting screen 142 through the projector 140 or on the digital signage 148 directly for the users 16a-16e.

It should be noted that the aforesaid user devices 12a-12e and manager device 14 are one embodiment for illustrating the features of the invention and the invention is not limited to the aforesaid embodiment. The user devices 12a-12e and the manager device 14 can be any possibly electronic devices, which are capable of communicating with the host device 10, can be operated by the users 16a-16e and the manager 18, and can display information for the users 16a-16e and the manager 18.

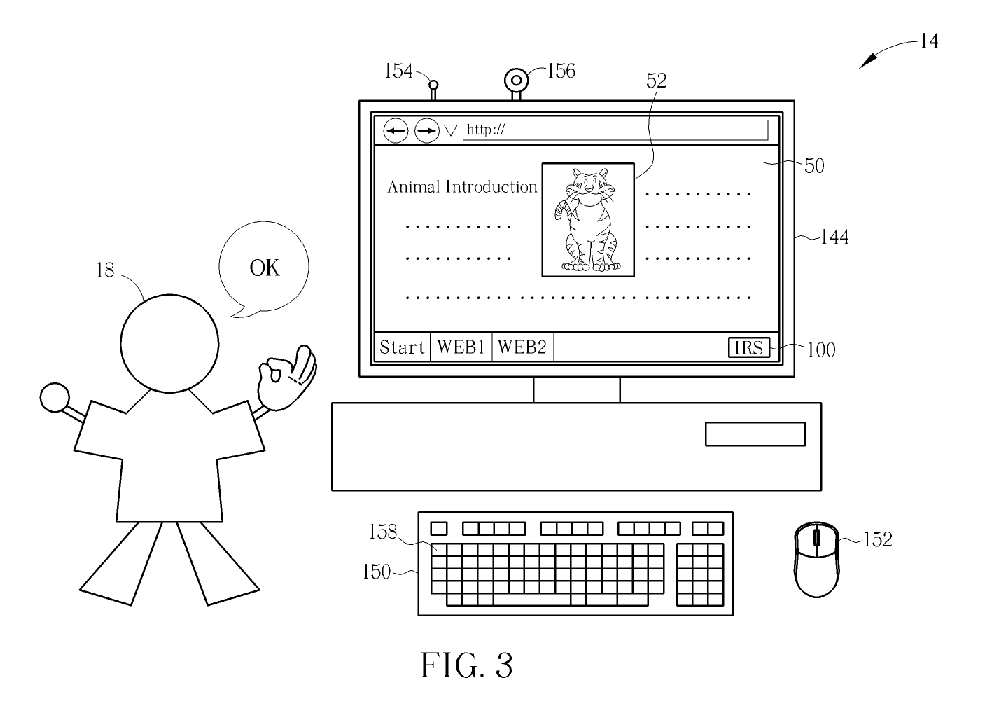

Referring to FIG. 3, FIG. 3 is a schematic diagram illustrating the manager 18 operating the computer 144 of the manager device 14 to browse an object 50. As shown in FIG. 3, the manager device 14 may further comprise a keyboard 150, a mouse 152, a microphone 154 and a camera 156. When the manager 18 wants to search a content for generating a question, he or she can switch the interactive response program 100 to a background mode so as to show the interactive response program 100 in a small icon at the tool list of the lower right corner, as shown in FIG. 3. At this time, the manager 18 can operate the manager device 14 to browse an object (e.g. Website, document, video or other files) in the host device 10 or the Internet 3. As shown in FIG. 3, when the manager 18 finds a content 52, which is suitable for generating questions, within the object 50, he or she can use the keyboard 150 and/or the mouse 152 to select the content 52 within the object 50 and then operate a hot operation module to trigger the interactive response program 100 to copy the content 52 to the memory module 102 of the host device 10.

In this embodiment, the aforesaid hot operation module may be a key 158 of the keyboard 150, the mouse 152, the microphone 154, the camera 156, or a combination thereof. After selecting the content 52 within the object 50, the manager 18 can press the key 158 to trigger the interactive response program 100 to copy the content 52 to the memory module 102 of the host device 10. After selecting the content 52 within the object 50, the manager 18 can also press right or left click of the mouse 152 to trigger the interactive response program 100 to copy the content 52 to the memory module 102 of the host device 10. After selecting the content 52 within the object 50, the manager 18 can also generate a voice (e.g. voice of “OK”) in front of the microphone 154 to trigger the interactive response program 100 to copy the content 52 to the memory module 102 of the host device 10. After selecting the content 52 within the object 50, the manager 18 can also perform a gesture (e.g. gesture of “OK”) in front of the camera 156 to trigger the interactive response program 100 to copy the content 52 to the memory module 102 of the host device 10. It should be noted that the aforesaid setting relative to the hot operation module can be determined based on practical applications and is not limited to the aforesaid embodiments.

In this embodiment, the manager 18 can browse different objects in the host device 10 or the Internet 3 through the aforesaid operations and copy a plurality of contents, which is suitable for generating questions, to the memory module 102 of the host device 10. It should be noted that the aforesaid content 52 may be a graph, a text, an animation or other forms based on practical applications.

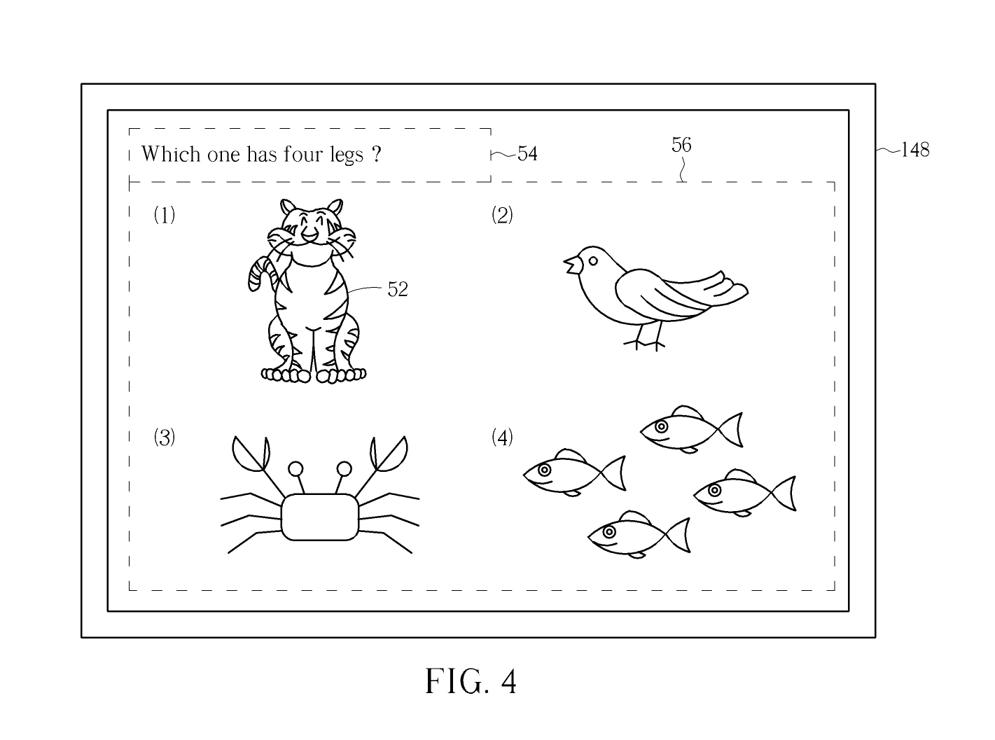

Afterward, the manager 18 can operate the manager device 14 to control the question generation module 104 of the interactive response program 100 to generate a question relative to the content 52 for the users 16a-16e to see and further operate the user devices 12a-12e to answer. Referring to FIG. 4, FIG. 4 is a schematic diagram illustrating a question 54 and the choice 56 corresponding thereto shown on the digital signage 148. After generating the question 54, the manager 18 can operate the hot operation module (e.g. the key 158 of the keyboard 150, the mouse 152, the microphone 154, the camera 156 or the combination thereof) according to the aforesaid operations to trigger the question generation module 104 to take the content 52 to be a choice 56 corresponding to the question 54. In other words, after generating the question 54, the manager 18 can press the key 158, press right or left click of the mouse 152, generate a voice in front of the microphone 154, or perform a gesture in front of the camera 156 to trigger the question generation module 104 of the interactive response program 100 to take the content, which is stored in the memory module 102, to be the choice 56 corresponding to the question 54 automatically. Then, the question 54 and the choice 56 corresponding thereto are displayed on the digital signage 148. It should be noted that the manager 18 can also use the projector 140 to display the question 54 and the choice 56 corresponding thereto on the projecting screen 142.

In this embodiment, the question generation module 104 may render the four choices 56 shown in FIG. 4 in a multimedia form, wherein the aforesaid multimedia form may comprise an animation, a voice or a combination thereof. For example, the four choices 56 may be displayed on the digital signage 148 or the projecting screen 142 sequentially in a slide form along with related voice. In another embodiment, the question generation module 104 may also display the four choices 56 shown in FIG. 4 on the digital signage 148 or the projecting screen 142 at the same time.

Furthermore, after copying a plurality of contents, which is suitable for generating questions, to the memory module 102 of the host device 10, the manager 18 can edit a plurality of questions with the contents. Afterward, the manager 18 can operate the hot operation module (e.g. the key 158 of the keyboard 150, the mouse 152, the microphone 154, the camera 156 or the combination thereof) according to the aforesaid operations to trigger the question generation module 104 of the interactive response program 100 to select at least one question from the plurality of questions for the users 16a-16e to see and further operate the user devices 12a-12e to answer. For example, if the manager 18 wants to generate five questions for the users 16a-16e to answer, he or she can press the key 158 of the keyboard 150 to trigger the question generation module 104 of the interactive response program 100 to select five questions from a question database of the memory module 102 randomly and then display the five questions on the digital signage 148 or the projecting screen 142 for the users 16a-16e to see and further operate the user devices 12a-12e to answer.

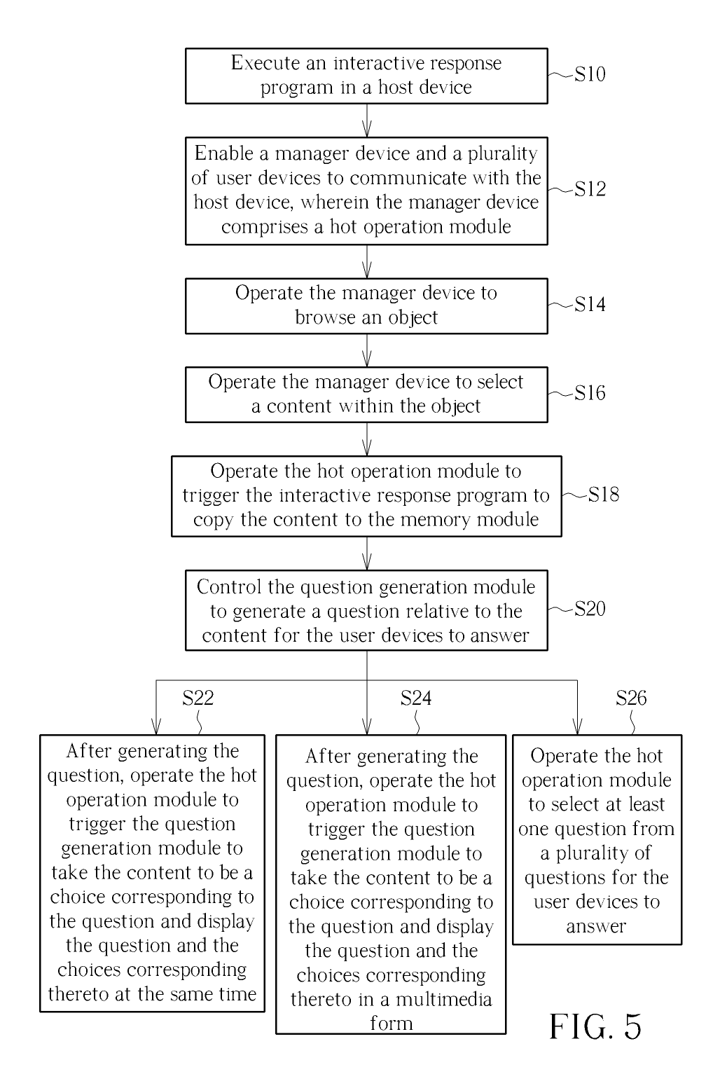

Referring to FIG. 5, FIG. 5 is a flowchart illustrating a question generation method for the interactive response system 1 according to an embodiment of the invention. The question generation method shown in FIG. 5 can be implemented by the interactive response system 1 shown in FIGS. 1 and 2. First of all, step S10 is performed to execute an interactive response program 100 in a host device 10. Afterward, step S12 is performed to enable a manager device 14 and a plurality of user devices 12a-12e to communicate with the host device 10, wherein the manager device 14 comprises the aforesaid hot operation module. Step S14 is then performed to operate the manager device 14 to browse an object 50. Step S16 is then performed to operate the manager device 14 to select a content 52 within the object 50. Step S18 is then performed to operate the aforesaid hot operation module to trigger the interactive response program 100 to copy the content 52 to the memory module 102. Step S20 is then performed to control the question generation module 104 to generate a question 54 relative to the content 52 for the user devices 12a-12e to answer.

In this embodiment, after generating the question 54, the manager 18 can operate the aforesaid hot operation module to trigger the question generation module 104 to take the content 52 to be a choice 56 corresponding to the question 54 and display the question 54 and the choices 56 corresponding thereto at the same time (step S22). Furthermore, after generating the question 54, the manager 18 can also operate the aforesaid hot operation module to trigger the question generation module 104 to take the content 52 to be a choice 56 corresponding to the question 54 and display the question 54 and the choices 56 corresponding thereto in a multimedia form (step S24). Moreover, the manager 18 can also operate the aforesaid hot operation module to select at least one question from a plurality of questions for the user devices 12a-12e to answer.

It should be noted that the control logics of the question generation method for the interactive response system 1 shown in FIG. 5 can be implemented by software. It is reasonably expected that each part or function of the control logics may be implemented by software, hardware or the combination thereof. Moreover, the control logics can be embodied by a computer readable storage medium, wherein the computer readable storage medium stores instructions, which can be executed by an electronic device so as to generate control command for controlling the electronic device to execute corresponding function.

As mentioned in the above, when a manager (e.g. teacher) operates the manager device to browse an object (e.g. Website, document, video or other files) and finds a content (e.g. graph, text, animation or other forms), which is suitable for generating questions, within the object, he or she can select the content within the object first and then operate the hot operation module to copy the content to the memory module of the host device. Afterward, the manager can operate the manager device to control the question generation module to generate a question relative to the content for users (e.g. students) to see and further operate the user devices to answer. The hot operation module of the invention may be a key, a mouse, a microphone, a camera, or a combination thereof. In other words, the manager only has to perform a trigger action (e.g. press the key, press the mouse, generate a voice in front of the microphone, perform a gesture in front of the camera, etc.) after selecting the desired content such that the interactive response program retrieves the desired content accordingly for question generation purpose. Therefore, the invention can simplify the operation of generating questions in the interactive response system effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interactive response system comprising:
a host device for executing an interactive response program, the host device comprising a memory module, the interactive response program comprising a question generation module;
a plurality of user devices communicating with the host device; and
a manager device communicating with the host device, the manager device comprising a hot operation module, the manager device being used for browsing an object and selecting a content within the object, the hot operation module being operated to trigger the interactive response program to copy the content to the memory module, the manager device controlling the question generation module to generate a question relative to the content for the user devices to answer.

2. The interactive response system of claim 1, wherein after generating the question, the hot operation module is operated to trigger the question generation module to take the content to be a choice corresponding to the question.

3. The interactive response system of claim 2, wherein the question generation module renders the choice in a multimedia form.

4. The interactive response system of claim 3, wherein the multimedia form comprises an animation, a voice, or a combination thereof.

5. The interactive response system of claim 1, wherein the memory module stores a plurality of questions, the hot operation module is operated to trigger the question generation module to select at least one question from the plurality of questions for the user devices to answer.

6. The interactive response system of claim 1, wherein the host device is linked with an Internet and the manager device browses the object in the Internet.

7. The interactive response system of claim 1, wherein the hot operation module comprises a key, a mouse, a microphone, a camera, or a combination thereof.

8. A question generation method for interactive response system comprising:
executing an interactive response program in a host device, wherein the host device comprises a memory module and the interactive response program comprises a question generation module;
enabling a manager device and a plurality of user devices to communicate with the host device, wherein the manager device comprises a hot operation module;
operating the manager device to browse an object;
operating the manager device to select a content within the object;
operating the hot operation module to trigger the interactive response program to copy the content to the memory module; and
controlling the question generation module to generate a question relative to the content for the user devices to answer.

9. The question generation method of claim 8, further comprising:
after generating the question, operating the hot operation module to trigger the question generation module to take the content to be a choice corresponding to the question.

10. The question generation method of claim 9, further comprising:
rendering the choice in a multimedia form.

11. The question generation method of claim 10, wherein the multimedia form comprises an animation, a voice, or a combination thereof.

12. The question generation method of claim 8, wherein the memory module stores a plurality of questions and the question generation method further comprises:
operating the hot operation module to trigger the question generation module to select at least one question from the plurality of questions for the user devices to answer.

13. The question generation method of claim 8, further comprising:
linking the host device with an Internet; and
operating the manager device to browse the object in the Internet.

14. The question generation method of claim 8, wherein the hot operation module comprises a key, a mouse, a microphone, a camera, or a combination thereof.
